(19) United States
(12) Patent Application Publication
(10) Pub. No.: US 2025/0092196 A1
(43) Pub. Date: Mar. 20, 2025

(54) METHOD FOR PRODUCING SELF-HEALING POLYMER, SELF-HEALING POLYMER PRODUCED THROUGH THE METHOD, AND ELECTRONIC DEVICE INCLUDING THE SAME

(71) Applicant: KOREA UNIVERSITY RESEARCH AND BUSINESS FOUNDATION, Seoul (KR)

(72) Inventors: Jeong Sook HA, Seoul (KR); Somin KIM, Gimhae-si (KR)

(73) Assignee: KOREA UNIVERSITY RESEARCH AND BUSINESS FOUNDATION, Seoul (KR)

(21) Appl. No.: 18/821,137

(22) Filed: Aug. 30, 2024

(30) Foreign Application Priority Data
Sep. 14, 2023 (KR) 10-2023-0122804

(51) Int. Cl. C08G 65/34

(52) U.S. Cl. CPC C08G 65/34

(57) ABSTRACT

Provided are a method for producing a self-healing polymer, which includes A) allowing polytetramethylene glycol (PTMG) and diisocyanate to react with each other at a first temperature, B) B) adding dimethylglyoxime (DMG) serving as a chain extender, which is melted in tetrahydrofuran (THF) serving as a solvent, to react with the reaction product in A) at a second temperature lower than the first temperature, C) reducing a temperature of a reaction product in B) to a third temperature lower than the second temperature and adding polydimethylsiloxane (PDMS), which is melted in THF to make a reaction, D) adding a crosslinker, which is melted in THF, to a reaction product in C) and stirring the result, and E) obtaining a polymer cured as the solvent is removed from a reaction product in D), the self-healing polymer produced through the method, and an electronic device including the self-healing polymer.

### CROSS-REFERENCE TO RELATED APPLICATIONS

This application claims priority under 35 U.S.C. § 119 to Korean Patent Application No. 10-2023-0122804 filed on Sep. 14, 2023, in the Korean Intellectual Property Office, the disclosures of which are incorporated by reference herein in their entireties.

### STATEMENT REGARDING GOVERNMENT SPONSORED RESEARCH OR DEVELOPMENT

The present invention is derived from a study conducted as part of the Individual Basic Research Program of the Ministry of Science and ICT (Project Identification Number: 1711188669, Project Number: 2022R1A2C2092575, Research Title: Functional Flexible Supercapacitor Process for Application of All-in-One Device for Skin Attachment, Conducting Institution: Korea University, Research Period: Sep. 1, 2022, to Feb. 28, 2027, Contribution Ratio: 1/2) and the Group Research Support Program of the Ministry of Science and ICT (Project Identification Number: 1711186153, Project Number: 2022R1A4A1031687, Project Management Institution: National Research Foundation of Korea, Conducting Institution: Korea University, Research Period: Jun. 1, 2022, to Feb. 28, 2025, Contribution Ratio: 1/2).

Meanwhile, there is no property interest of the Korean government, which is the subject of providing the task, in any aspect of the present invention.

### BACKGROUND

Embodiments of the present disclosure described herein relate to a method for producing a self-healing polymer, a self-healing polymer produced through the method, and an electronic device including the self-healing polymer.

Recently, as studies and researches have been actively performed on a wearable device attached to or transferred to a human body, studies and researches on increasing the lifespan of a material have been spotlighted. To increase the lifespan of the wearable device, the wearable device should be stretchable such that the wearable device is stable against various deformations, such as elongating or bending, and should have a self-healing functionality against damage. To apply the wearable device to a daily life, the wearable device should have the design of a molecular structure and a component carefully selected, such that the wearable device is stable against various modifications and has the self-healing function.

In addition, device damage by external force is frequently caused in a portable device, and the necessity to solve the economic and environment problems caused by devices discarded due to the damage has been raised.

### SUMMARY

Embodiments of the present disclosure provide a method for producing a self-healing polymer, a self-healing polymer produced through the method, and an electronic device including the self-healing polymer, capable of synthesizing a polymer, which is durable and has a selective self-healing function, and of increasing the lifespan of a device by introducing a self-healing material by introducing an oxime-carbomate bond having a dynamic covalent bond activated at a specific temperature.

Embodiments of the present disclosure provide a method for producing a self-healing polymer, a self-healing polymer produced through the method, and an electronic device including the self-healing polymer, capable of controlling a material having a self-healing function such that a self-healing characteristic of the material appears at a specific temperature or more, thereby selectively controlling the self-healing characteristic of the material.

Meanwhile, the technical problems that are achieved in the present disclosure may not be limited to what has been described herein, and other technical problems not described herein may be clearly understood from the following detailed description by persons skilled in the art.

According to a first embodiment of the present disclosure, there may be provided a method for producing a self-healing polymer, which include A) allowing polytetramethylene glycol (PTMG) and diisocyanate to react with each other at a first temperature, B) adding dimethylglyoxime (DMG) serving as a chain extender, which is melted in tetrahydrofuran (THF) serving as a solvent, to react with the reaction product in A) at a second temperature lower than the first temperature, C) reducing a temperature of a reaction product in B) to a third temperature lower than the second temperature and adding polydimethylsiloxane (PDMS), which is melted in THF, such that the PDMS melted in the THF is allowed to react with the reaction product in B), D) adding a crosslinker, which is melted in THF, to a reaction product in C) and stirring the crosslinker and the reaction product in C), and E) obtaining a polymer cured as the solvent is removed from a reaction product in D).

In addition, there may be provided the method for producing the self-healing polymer, in which the PTMG constitutes a soft segment of the self-healing polymer, and the diisocyanate constitutes a hard segment of the self-healing polymer.

There may be provided the method for producing the self-healing polymer, in which the soft segment and the hard segment constitute a dynamic covalent bond.

In addition, there may be provided the method for producing the self-healing polymer, in which the soft segment and the hard segment constitute an oxime-carbamate bond having a dynamic covalent bond activated at a preset threshold temperature.

In addition, there may be provided the method for producing the self-healing polymer, in which the threshold temperature is higher than a glass transition temperature of the self-healing polymer produced.

In addition, there may be provided the method for producing the self-healing polymer, in which the diisocyanate includes at least one selected from the group consisting of isophorone diisocyanate, methylene diphenyl diisocyanate, and hexamethylene diisocyanate,

In addition, there may be provided the method for producing the self-healing polymer, in which the crosslinker includes at least one selected from the group consisting of diethylene triamine, meta-phenylene diamine, tetraethylene pentamine, diethanolamine, and triethanolamine.

In addition, there may be provided the method for producing the self-healing polymer, in which a molecular ratio of the PDMS to the PTMG ranges from 4:1 or 1:1 to 1:4.

In addition, there may be provided the method for producing the self-healing polymer, in which the crosslinker is added in a proportion ranging from 1% to 2% based on a volume ratio of a solvent.

In addition, according to a second embodiment of the present disclosure, there may be provided a self-healing polymer produced through the method for producing the self-healing polymer described above.

In addition, there may be provided the self-healing polymer, in which the self-healing polymer is split physically, and bonded physically, as self-healing is activated at at least a preset threshold.

In addition, there may be provided an electronic device including the self-healing polymer.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1A is a view illustrating a procedure for producing a self-healing polymer according to an embodiment of the present disclosure;

FIG. 1B is a view schematically illustrating a structural formula of a self-healing polymer according to an embodiment of the present disclosure;

FIG. 2 is an enlarged view expressed by enlarging an oxime-carbamate bond structure of FIGS. 1A and 1B;

FIG. 3 is a view schematically illustrating the self-healing polymer produced through the method for producing the self-healing polymer and a self-healing procedure according to an embodiment of the present disclosure;

FIG. 4A illustrates an FT-IR spectrum of a self-healing polymer produced;

FIG. 4B illustrates an H-NMR spectrum;

FIG. 5A illustrates curves of thermogravimetric analysis (TGA) and derivative thermogravimetry (DTG) of a self-healing polymer produced;

FIG. 5B illustrates a curve of a DSC spectrum;

FIG. 6A is a graph illustrating a mechanical property of matter, based on a ratio of PTMG:PDMS;

FIG. 6B is a graph illustrating a self-healing efficiency based on the ratio of PTMG:PDMS;

FIG. 6C is a graph illustrating a mechanical property based on the concentration of the crosslinker;

FIG. 6D is a graph illustrating a self-healing efficiency depending on the concentration of a crosslinker;

FIG. 7A illustrates a dynamic mechanical analysis (DMA) curve (a temperature sweep);

FIG. 7B illustrates a DMA curve (a frequency sweep);

FIG. 7C illustrates a hysteresis curve of a self-healing polymer produced;

FIG. 7D illustrates a stain-stress curve illustrating a mechanical property of matter before self-healing (black color) of the self-healing polymer produced and after self-healing (red color) of a self-healing polymer produced;

FIG. 7E is a graph illustrating the self-healing efficiency depending on the temperature;

FIG. 7F is a graph illustrating the self-healing efficiency depending on the time for self-healing at the temperature of 65° C.;

FIG. 8 is an image obtained by capturing a scratched part over time.

FIG. 9A illustrates an electronic device according to another embodiment of the present disclosure;

FIG. 9B is a view schematically illustrating a healing procedure of an electronic device according to another embodiment;

FIG. 10A is a graph illustrating the sensitivity of a pressure sensor depending on the number of times of repeating self-healing;

FIG. 10B is a graph illustrating the change in capacitance when mutually different pressures are repeatedly applied;

FIG. 10C is a graph illustrating the change in capacitance when equal pressure is repeated 5,000 times;

FIG. 10D is a graph illustrating the change in capacitance due to finger bending before and after self-healing;

FIG. 10E is a graph illustrating the change in capacitance due to wrist bending before and after self-healing;

FIG. 10F is an image showing that an LED is turned on depending on the change in pressure in water;

FIG. 11A is a view illustrating a process for manufacturing an electronic device and the structure of the electronic device according to another embodiment of the present disclosure;

FIG. 11B is a view illustrating the defects in an interface of the electronic device according to another embodiment of the present disclosure;

FIG. 11C is an image illustrating an electronic device according to another embodiment of the present disclosure; and

FIG. 12 illustrates the change in capacitance before and after self-healing in an electronic device according to another embodiment of the present disclosure.

### DETAILED DESCRIPTION

Hereinafter, an embodiment of the present disclosure will be described in more detail with reference to the accompanying drawings. The embodiments of the present disclosure may be modified in various forms, and the scope of the present disclosure should not be construed to be limited by the embodiments of the present disclosure described in the following. The embodiments of the present disclosure are provided to describe the present disclosure for those skilled in the art more completely. Accordingly, the shapes and the like of the components in the drawings are exaggerated to emphasize clearer descriptions.

Hereinafter, the feature of the present disclosure will be described in detail with reference to exemplary embodiments and accompanying drawings to clarify solutions of problems to be solved according to the present disclosure. In the following description, the same reference numerals will be assigned to the same components even though the components are illustrated in different drawings. In addition, when the description is made with reference to a present drawing, a component in another drawing may be cited if necessary.

An embodiment of the present disclosure relates to a polymer which has a stretchable characteristic, a durable characteristic, and a selectively self-healing characteristic. An oxime-carbamate bond having the dynamic covalent bond activated by heat was applied to polyurethane having abundant hydrogen bonds, such that a polymer having a higher self-healing efficiency at a higher specific temperature was synthesized.

In addition, as diethylenetriamine, which serves as a crosslinker to form a covalent bond, was introduced, the chemical stability was ensured. As poly(tetramethylene glycol) and poly(dimethyl siloxane) were employed for a soft segment of polyurethane, a mechanical property of matter and a hydrophobic property appeared.

In addition, as isophorone diisocyanate was employed for a hard segment of the polyurethane, the fluidity of the polymer was ensured through steric hindrance to adjust a glass transition temperature.

According to a detailed experimental example, the synthesized polymer was able to be stretched up to 1,100%. In addition, the synthesized polymer showed the higher mechanical property of matter in that a tensile strength was 1.23 MPa at a breaking point. In addition, the synthesized polymer did not show the self-healing characteristic at the temperature of 65° C. or less, and the synthesized polymer showed a higher self-healing efficiency of 93.7% in the contact for six hours at the temperature of more than 65° C.

In addition, according to another embodiment of the present disclosure, a capacitive pressure sensor was manufactured with the self-healing performance based on the synthesized polymer. The synthesized polymer, nickel (Ni), and galinstan micro-particles were employed for an electrode, and the synthesized polymer was employed for a dielectric layer, such that layers were assembled through inter-layer self-healing. As nickel and galinstan micro-particles were employed together, the resistance of an electrode was changed depending on pressure. Accordingly, a sensor having higher sensitivity was manufactured.

The manufactured pressure sensor showed the stable change in capacitance by pressure repeatedly applied, and maintained stable sensitivity even after self-healing five times. The pressure sensor determined the bending of a finger and a wrist depending on angles. When the polymer developed in the present disclosure was used as a capsule layer, the pressure sensor was stably driven even underwater. A 4×4 sensor array was manufactured based on a single sensor. Regarding an interconnection between sensors, after a gold pattern was formed through a photolithography process, an interconnection having a stretchable function and a self-healing function was manufactured using selective wettability of galinstan for gold.

It was recognized that the position and the intensity of pressure applied in a second dimensional space were determined through the sensor-array manufactured, and this characteristic was maintained even after the array is completely cut.

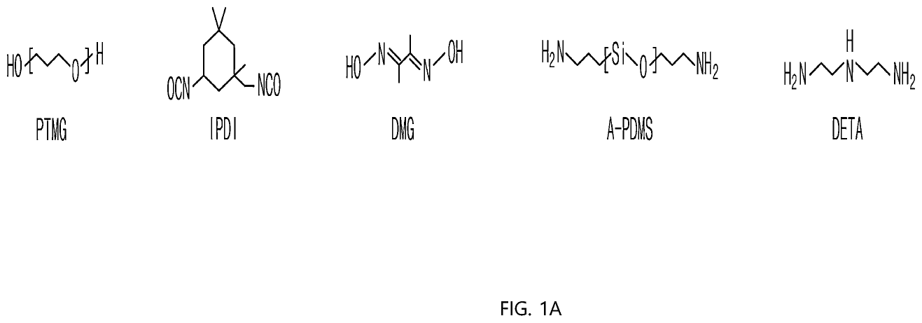

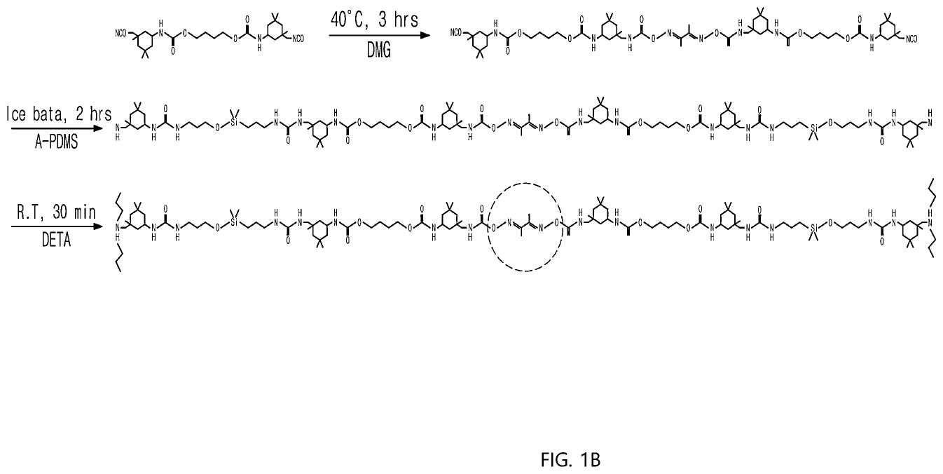

Hereinafter, the method for producing the self-healing polymer according to an embodiment of the present disclosure will be described with reference to FIGS. 1A and 1B.

Referring to FIGS. 1A and 1B, the method for producing the self-healing polymer according to an embodiment of the present disclosure includes step A) for allowing polytetramethylene glycol (PTMG) and diisocyanate to react with each other at a first temperature, step B) for adding dimethylglyoxime (DMG), which is melted in tetrahydrofuran (THF), to the reaction product in the step A) such that DMG melted in THF is allowed to react with the reaction product at a second temperature lower than the first temperature, step C) for reducing the temperature of the reaction product in the step B) to a third temperature lower than the second temperature and adding polydimethylsiloxane (PDMS) which is melted in THF such that PDMS melted in THF is allowed to react with the reaction product in the step C), step D) for adding a crosslinker, which is melted in THF, to the reaction product in the step C) and stirring the crosslinker and the reaction product in the step C), and step E) for acquiring cured polymer by removing a solvent from a reaction product in the step D).

In this case, the reaction in the step A) may be defined as a dehydration reaction between a hydroxyl group at the terminal of PTMG and an isocyanate group of diisocyanate.

In addition, the reaction in the step B) may be defined as a dehydration reaction between an isocyanate group at the terminal of the reaction product obtained in the step A) and a hydroxyl group at the terminal of the DMG.

In addition, the reaction in the step C) may be defined a dehydration reaction between an isocyanate group at the terminal of the reaction product obtained in the step B) and an amino group at the terminal of PDMS.

In this case, the first temperature may be about 100° C., the second temperature may be about 40° C., and the third temperature may be set to about 10° C.

In this case, the reaction between the amino group (—NH₂) at the terminal of the PDMS and the isocyanate group (—NCO) significantly rapidly made, as compared to the reaction between the hydroxyl group (—OH) and the isocyanate group (—NCO). Accordingly, the reaction temperature of the steps A), B), and C) is gradually lowered such that the reactants are uniformly mixed. Accordingly, the reaction efficiency may be improved.

In this case, the PTMC may constitute the soft segment of the self-healing polymer, and the diisocyanate may constitute the hard segment of the self-healing polymer. The soft segment and the hard segment may form a dynamic covalent bond and may form an oxime-carbamate bond having the dynamic covalent bond activated at a preset threshold temperature or more.

In this case, the above-described threshold temperature is preferably higher than the glass transition temperature of the self-healing polymer produced. Meanwhile, the diisocyanate may include at least one selected from the group consisting of isophorone diisocyanate, methylene diphenyl diisocyanate, and hexamethylene diisocyanate, and the crosslinker may include at least one selected from the group consisting of diethylene triamine, meta-phenylene diamine, tetraethylene pentamine, diethanolamine, and triethanolamine.

In addition, the molar proportion of PDMS molecules is preferably 25% or less (greater than 0%) with respect to PTMG.

In this case, when the molar proportion of PDMS molecules preferably ranges from 25% to 400%, with respect to PTMG, the entanglement of the PDMS chain acts as a crosslinking point to reduce the stretchability and the self-healing efficiency of the polymer, and the self-healing efficiency is gradually increased as the proportion of the urethane group at the terminal of the PDMS segment is increased. Meanwhile, as the proportion of the PDMS is increased, a higher Young's modulus is shown by the crosslinking point in a lower elongation section, and the proportion for the crystalline segment of the PTMS chain is reduced after the yield point such that the stress is reduced. This refers to that lower elasticity is shown when the molar proportion of PDMS molecules is 100% or more with respect to PTMG.

In this case, when the proportion of PDMS is 400% or more with respect to PTMG, the higher self-healing efficiency is shown, but the lower elasticity is shown. When the proportion of PMDS ranges from 25% to 400% with respect to PTMG, the lower self-healing efficiency is shown. Accordingly, it is most preferable that the proportion of PDMS is less than 25% (over 0%) with respect to PTMG.

In addition, the addition ratio of the crosslinker preferably ranges from 1% to 2% based on the volume ratio of the solvent.

When the crosslinker is added 1% or less, the elasticity is significantly lowered. When the crosslinker is 2% or more, the self-healing efficiency is significantly lowered.

Accordingly, specific embodiments are as follows.

### Embodiment

1) Under a nitrogen atmosphere, 2 g of PTMG is allowed to react with 1.02 g of IPDI at the temperature of 110° C. for two hours. 2) 0.17 g of dimethylglyoxime (DMG), which is melted in 5 mL tetrahydrofuran (THF), is added to the product and allowed to react with a reactant at the temperature of 40° C. for three hours. 3) After the temperature of the reactant is lowered to 10° C. or less, and 4) 1.25 g of PDMS, which is melted in 5 mL of THF, is added to the reactant and allowed to react with the reactant for two hours. 5) 0.1 mL of DETA melted in 5 mL of THF is added to a reactant and then stirred for 30 minutes or more. 6) A polymer solution subject to the reaction is put into a Teflon mold and left at a normal temperature under normal pressure for one day or more, and the solvent is removed to obtain a polymer film cured.

### Characteristic Evaluation

Referring to FIGS. 1A to 8, it may be recognized that the self-healing polymer produced through the method for producing the self-healing polymer according to an embodiment of the present disclosure has following characteristics.

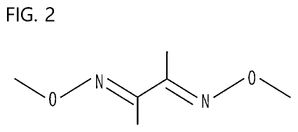

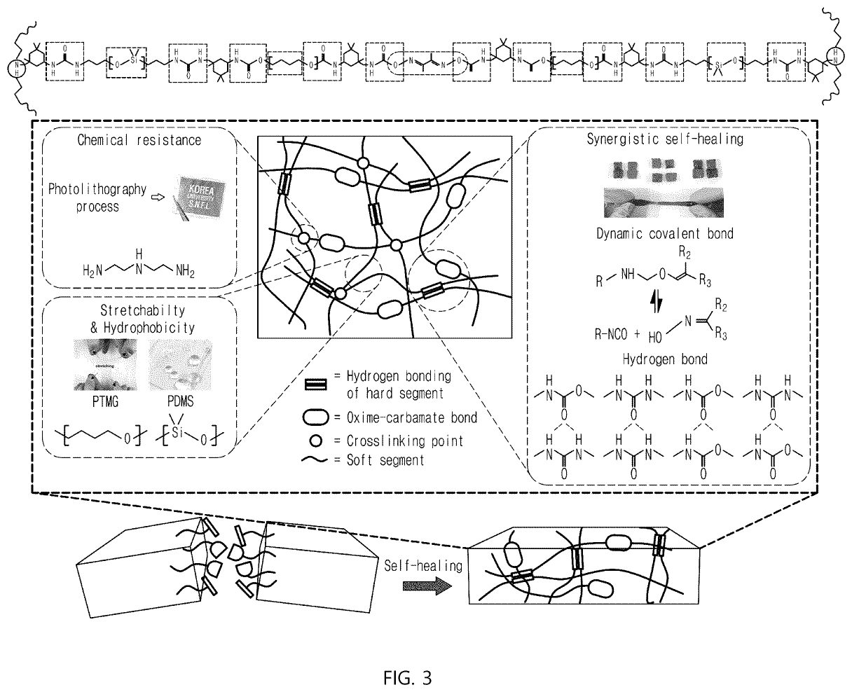

FIGS. 1A and 1B are views schematically illustrating the process for producing the self-healing polymer and the structural formula of the self-healing polymer according to an embodiment of the present disclosure. FIG. 2 is an enlarged view obtained by enlarging the structure of the oxime-carbamate bond of FIGS. 1A and 1B are views. FIG. 3 is a view schematically illustrating the self-healing polymer produced through the method for producing the self-healing polymer and a self-healing process according to an embodiment of the present disclosure.

Referring to FIGS. 1A and 3, the self-healing polymer produced through the method for producing the self-healing polymer according to an embodiment of the present disclosure has a self-healing characteristic activated only at the temperature of 65° C. or more.

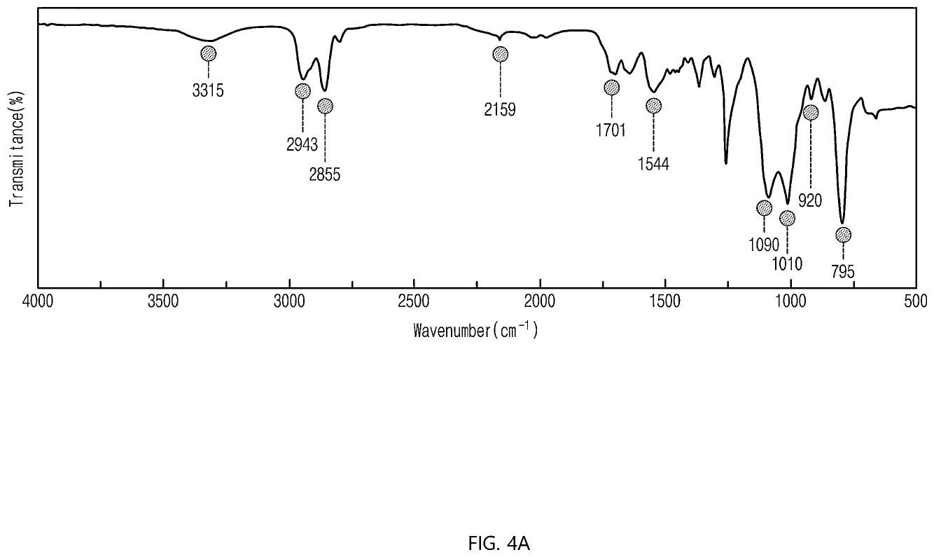

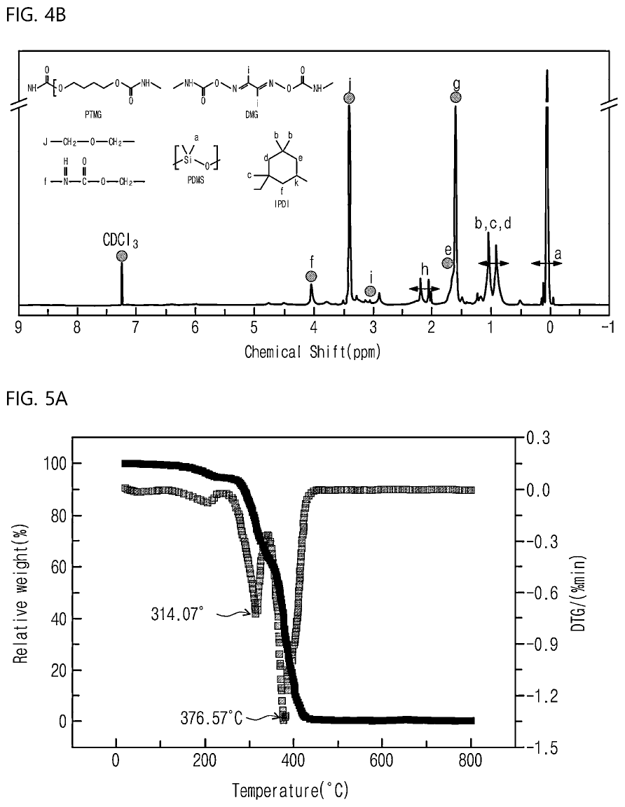

In addition, FIG. 4A illustrates an FT-IR spectrum of the self-healing polymer produced, and FIG. 4B illustrates an H-NMR spectrum of the self-healing polymer produced. Referring to FIGS. 4A and 4B, a relevant peak is not shown in the isocyanate group. Accordingly, it may be recognized that the reaction among the isocyanate group, the hydroxyl group, and the amino group is successfully made.

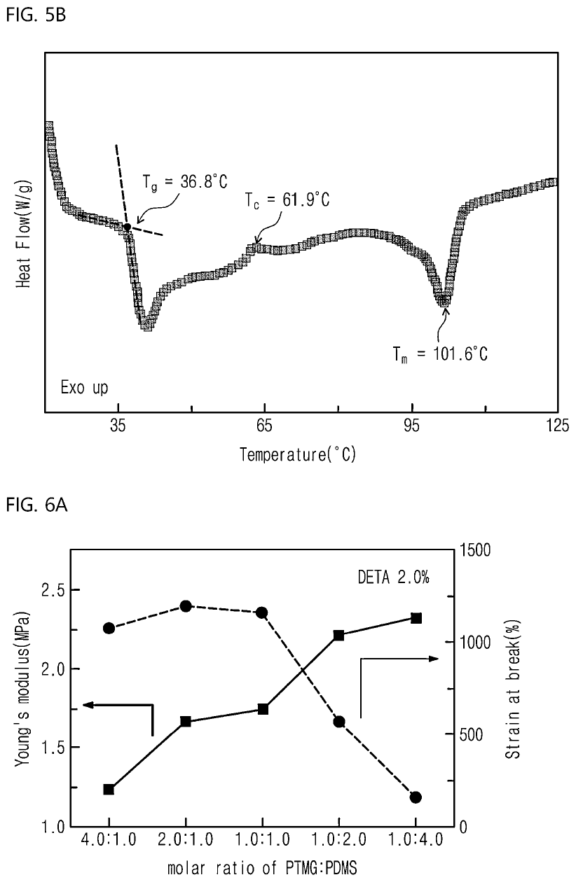

FIG. 5A illustrates curves of TGA and DTG of the self-healing polymer produced, and FIG. 5B illustrates a curve of DSC. Referring to FIGS. 5A and 5B, the produced self-healing polymer shows the thermal stability up to about 300° C. and shows a glass transition temperature at about 37° C., as the self-healing polymer, which is produced, is subject to a primary pyrolysis at the temperature of about 314° C. and subject to a secondary pyrolysis at the temperature of about 376° C.

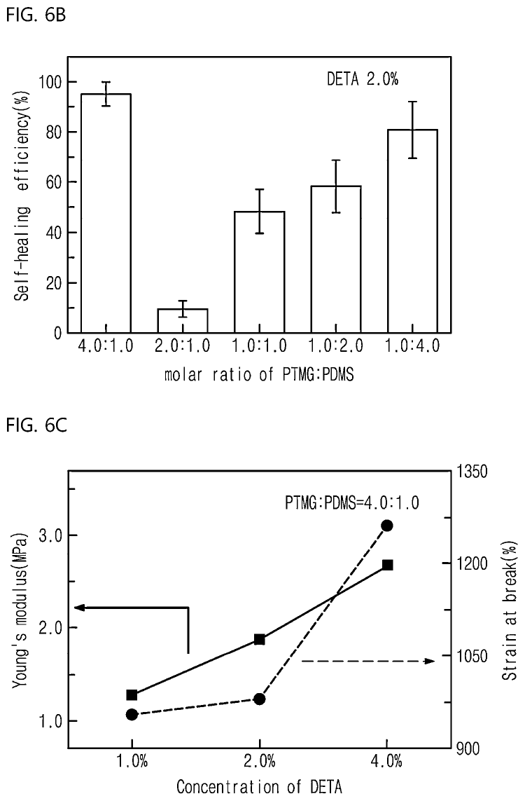

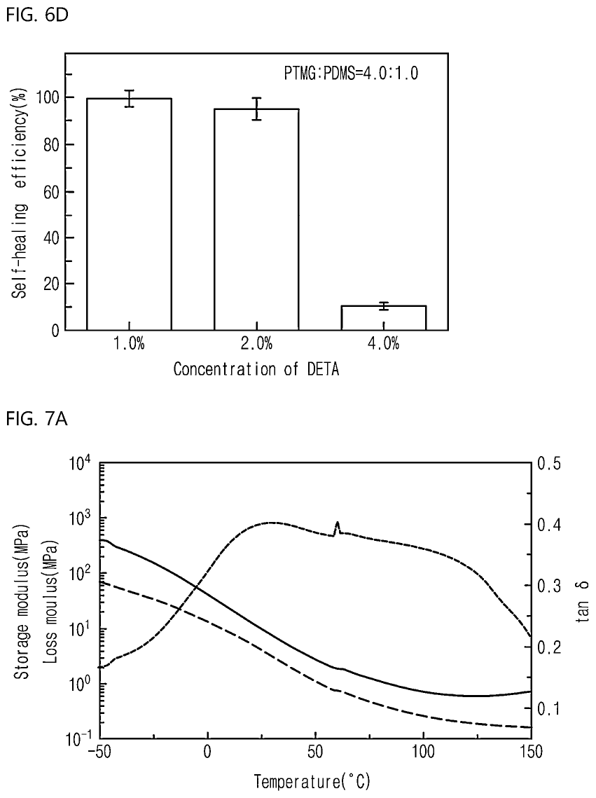

FIG. 6A is a graph illustrating a mechanical property of matter based on the ratio of PTMG:PDMS, FIG. 6B is a graph illustrating a self-healing efficiency based on the ratio of PTMG:PDMS. FIG. 6C is a graph illustrating a mechanical property of matter, based on the concentration of the crosslinker, and FIG. 6D is a graph illustrating the self-healing efficiency depending on the concentration of the crosslinker. Referring to FIGS. 6A to 6B, as the proportion of PDMS is increased, the Young's modulus is increased, and an elongation is decreased at a break point. When the ratio of PTMG:PDMS ranges from 2:1 to 1:4, as the proportion of the PDMS is increased, the self-healing efficiency is increased.

Referring to FIGS. 6C and 6D, as the concentration of the crosslinker is increased, the Young's modulus and the elongation are increased at the break point, and the self-healing efficiency is reduced.

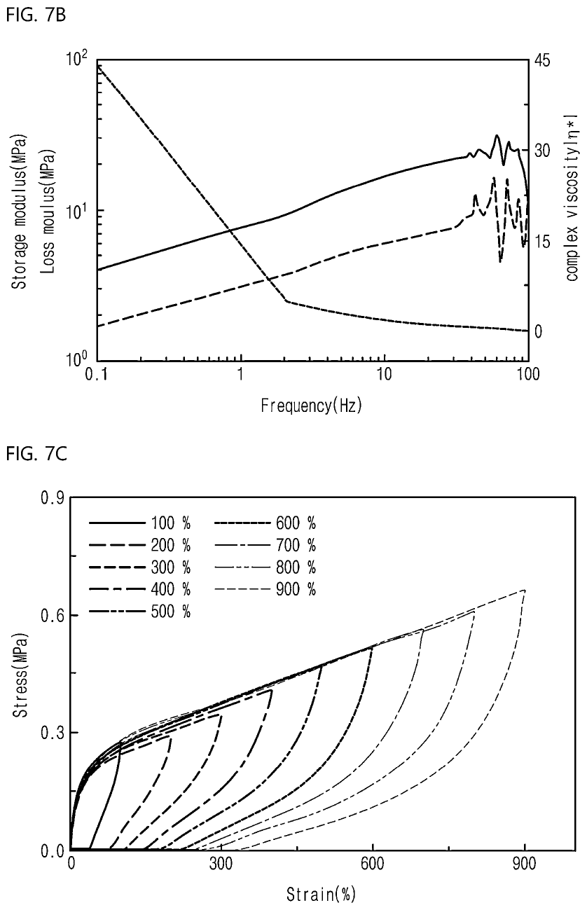

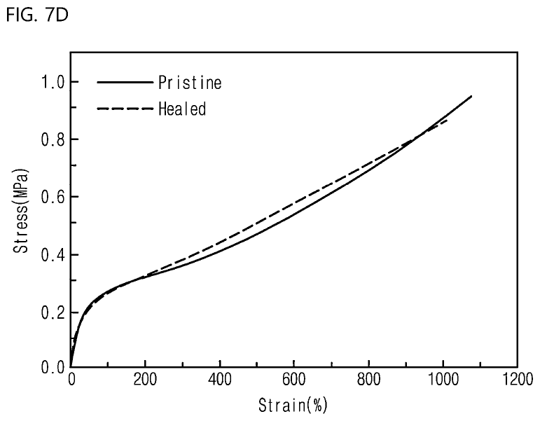

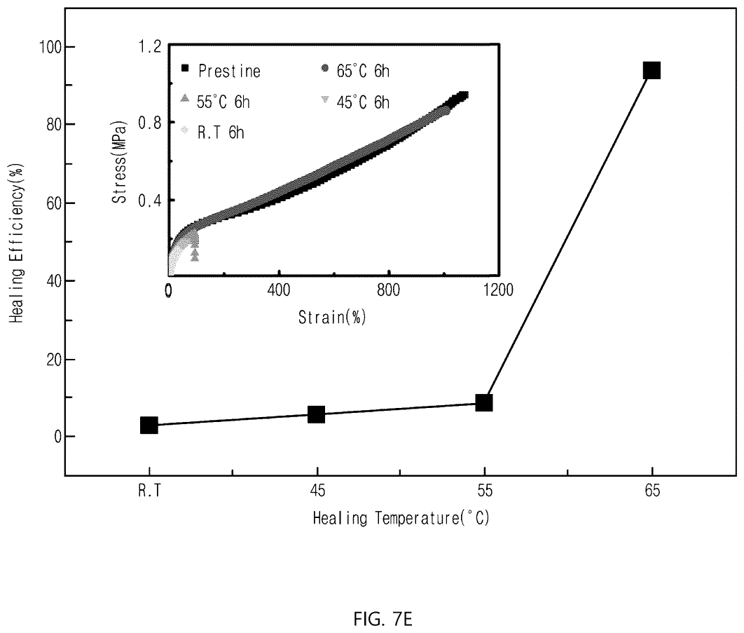

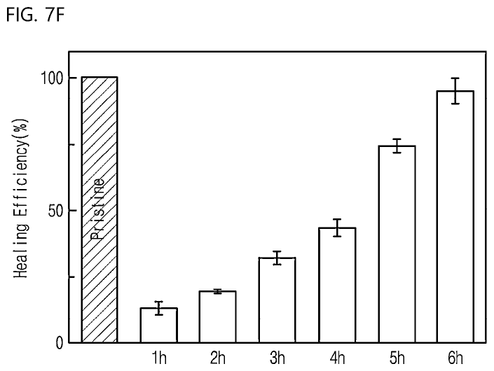

FIG. 7A illustrates a dynamic mechanical analysis (DMA) curve (a temperature sweep). FIG. 7B illustrates a DMA curve (a frequency sweep). FIG. 7C illustrates a hysteresis curve of a self-healing polymer produced. FIG. 7D illustrates a stain-stress curve illustrating a mechanical property of matter before self-healing (black color) of the self-healing polymer produced and after self-healing (red color) of a self-healing polymer produced. FIG. 7E is a graph illustrating the self-healing efficiency depending on the temperature, and FIG. 7F is a graph illustrating the self-healing efficiency depending on the time for self-healing at the temperature of 65° C. Referring to FIGS. 7A to 7B, the self-healing polymer produced has elasticity, as the higher storage modules is shown in the whole domains of the temperature and the frequency. Referring to FIG. 7C, hysteresis is present when external force is removed after the self-healing polymer produced is stretched. Referring to FIG. 7D, the mechanical property of matter of the self-healing polymer produced is recovered before and after the self-healing when the self-healing polymer is left at the temperature of 65° C. for six hours. Referring to FIG. 7E, the self-healing efficiency is significantly lowered at the temperature of 55° C. or less, and the self-healing efficiency is rapidly increased at the temperature of 65° C. or more. Referring to FIG. 7F, the self-healing efficiency is increased over time, when the cut-surface of the self-healing polymer produced at the temperature of 65° C. is left in contact.

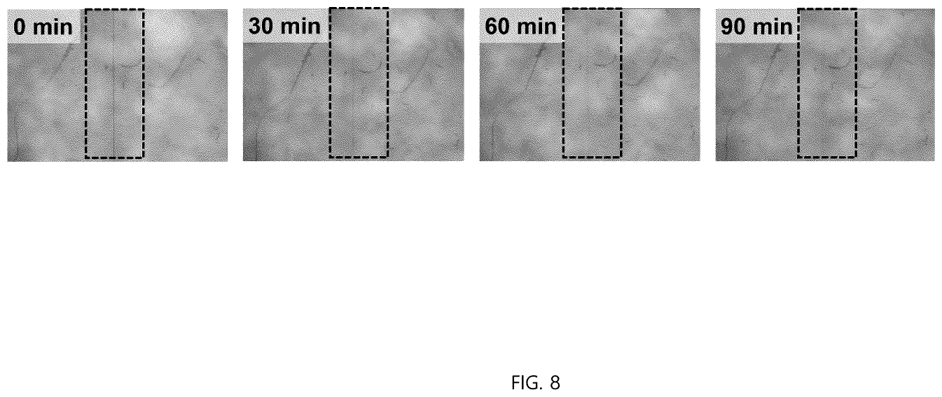

FIG. 8 is a surface image over time when a scratch is made on the self-healing polymer produced and then left at 65° C. Referring to FIG. 8, the scratch is disappeared over time.

### Manufacturing for Electronic Device (Sensor) Including Self-Healing Polymer

The electronic device according to another embodiment of the present disclosure may be manufactured through following processes.

Using an ultra-sound wave, 0.4 g of Ni particles and 0.2 g of galinstan particles are dispersed in 20 mL of ethanol. To obtain Ni/galinstan particles in uniform size, a dispersion solution is left for two hours and then a supernatant is removed. After the remaining ethanol is all evaporated, 0.6 g of Ni/galinstan particles remaining are uniformly mixed with 0.375 mL of the solution of the synthesized polymer and 1.5 mL of THF, and then cured to manufacture an electrode.

Thereafter, a self-healing polymer film, which is prepared thereafter, having the thickness of 250 μm is assembled with the two manufactured electrodes. The assembled sensor is placed at 65° C. for 6 hours or more to complete a sensor through a self-healing process to prevent inter-layer delamination.

### Manufacturing of Self-Healing Sensor Array

After forming a metal pattern having thickness of 100 μm, on the self-healing polymer through the photolithography process, the sensor electrode is patterned and cured using a stencil mask. An interconnection is formed on a gold pattern using galinstan reduced to 1 wt % of NaOH. The self-healing polymer film having the thickness of 250 μm is inserted between the two electrode arrays manufactured, and placed at the temperature of 65° C. for six hours, thereby preventing the interlayer lamination.

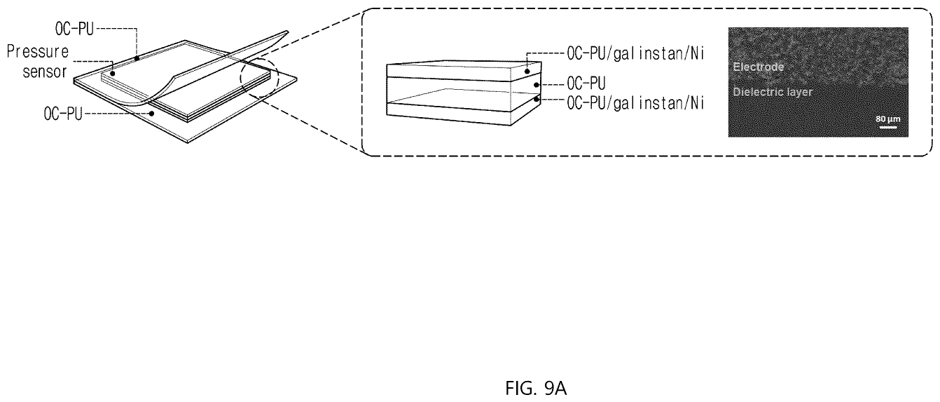

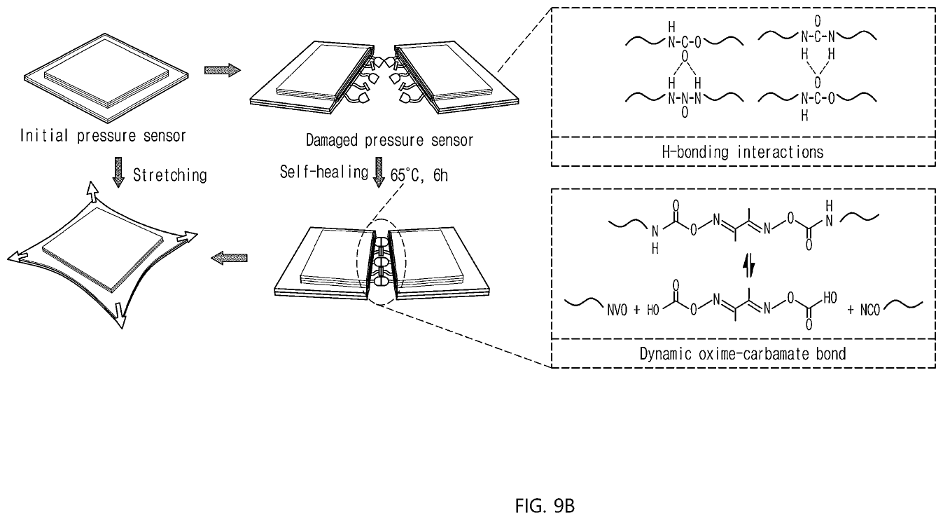

FIG. 9A illustrates an electronic device according to another embodiment of the present disclosure, and FIG. 9B is a view schematically illustrating the healing procedure of the electronic device according to another embodiment of the present disclosure. Referring to FIGS. 9A to 9B, in the electronic device according to another embodiment of the present disclosure, layers are completely integrated with each other through the self-healing process.

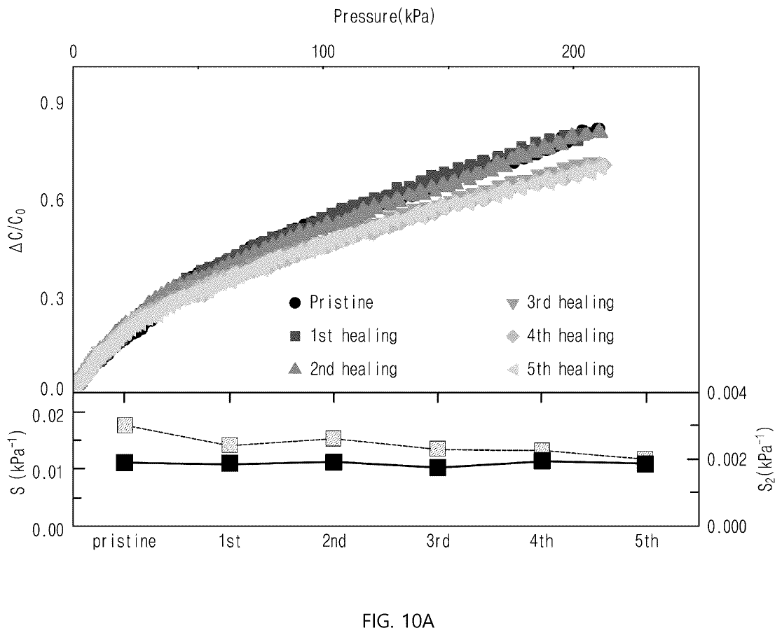

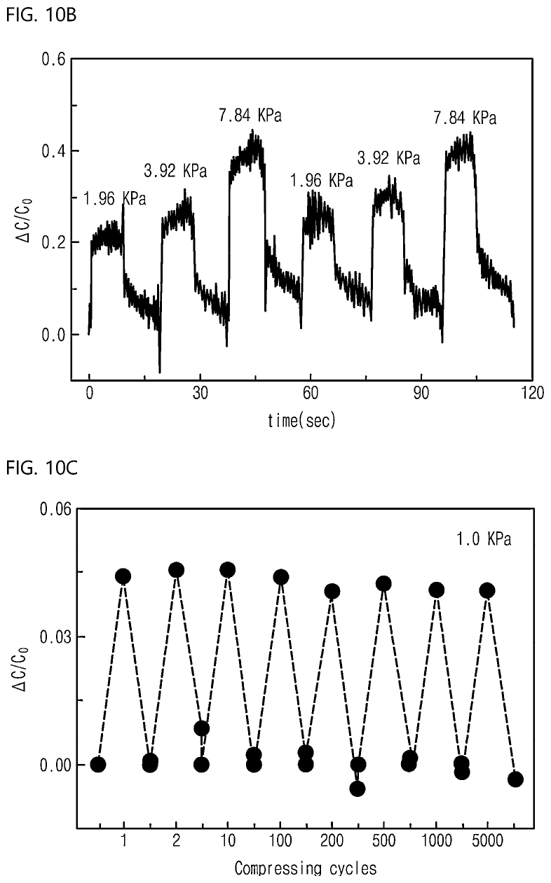

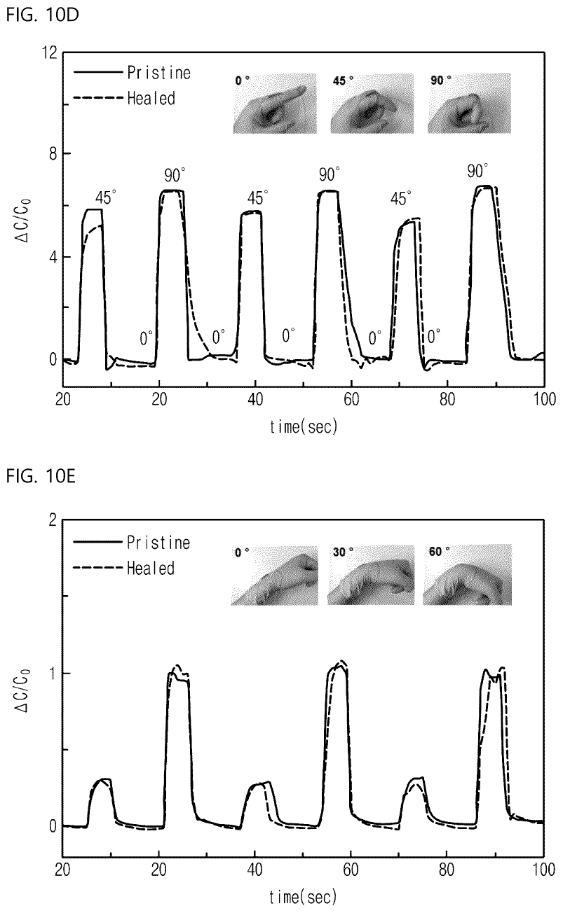

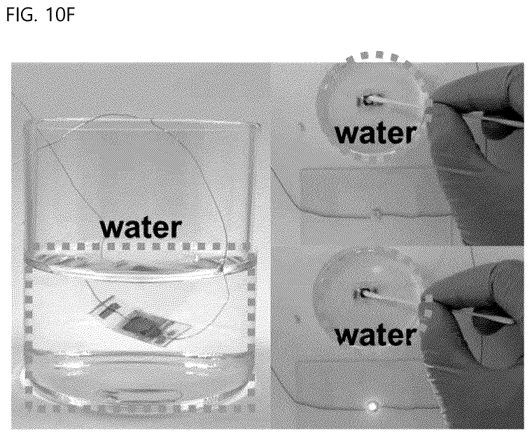

FIG. 10A is a graph illustrating the sensitivity of a pressure sensor depending on the number of times of repeating self-healing, FIG. 10B is a graph illustrating the change in capacitance when mutually different pressures are repeatedly applied, and FIG. 10C is a graph illustrating the change in capacitance when equal pressure is repeated 5,000 times. Referring to FIGS. 10A to 10C, according to another embodiment of the present disclosure, the performance of the electronic device is almost maintained even after five self-healing processes, and the higher cycle stability is shown. FIG. 10D is a graph illustrating the change in capacitance due to finger bending before and after self-healing, FIG. 10E is a graph illustrating the change in capacitance due to wrist bending before and after self-healing, and FIG. 10F is an image showing that an LED is turned on depending on the change in pressure in water. Referring to FIGS. 10D to 10F, movement of a human body may be sensed by using the electronic device according to another embodiment of the present disclosure and the electronic device is driven underwater.

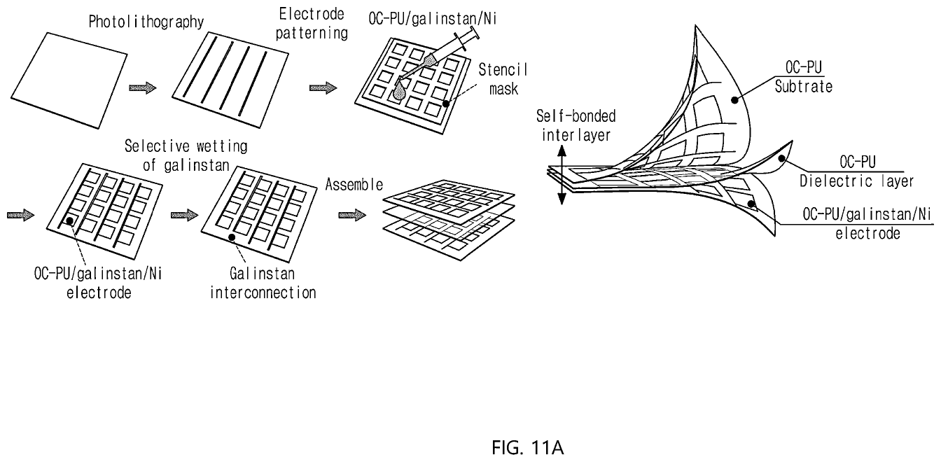

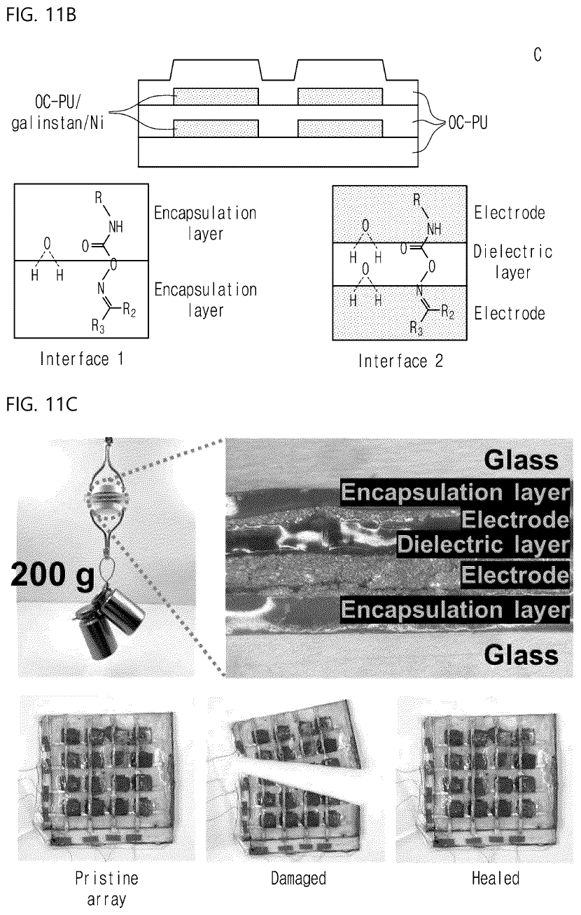

FIG. 11A is a view illustrating the process for manufacturing the electronic device and the structure of the electronic device according to another embodiment of the present disclosure, FIG. 11B is a view illustrating the defects in an interface of the electronic device according to another embodiment of the present disclosure, and FIG. 11C is an image illustrating the electronic device according to another embodiment of the present disclosure. Referring to FIGS. 11A to 11C, the electronic device according to another embodiment of the present disclosure may be manufactured in the form of an array through a photolithography process, and layers of the electronic device are integrated with each other through the self-healing process through a hydrogen bond and an oxime-carbamate bond.

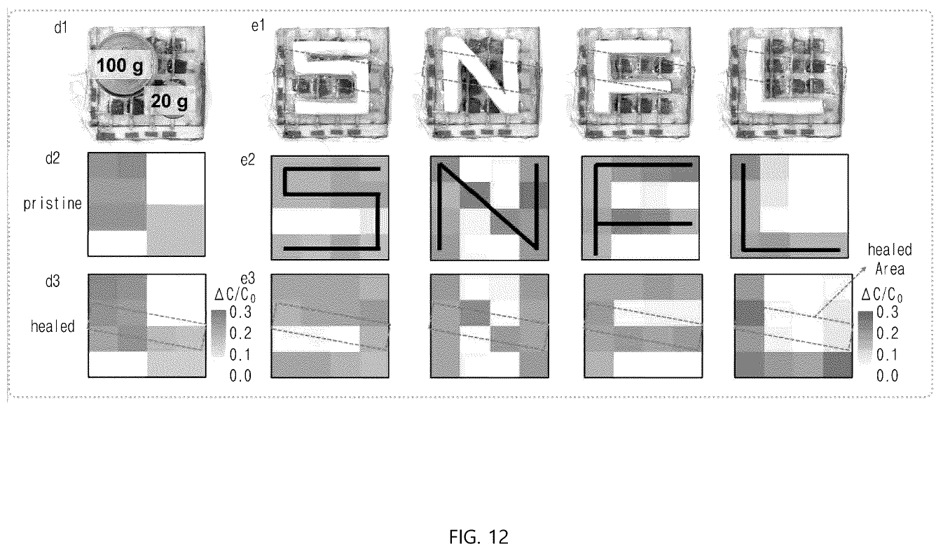

FIG. 12 illustrates the change in capacitance before and after self-healing in an electronic device according to another embodiment of the present disclosure.

Referring to FIG. 12, the position and the intensity of pressure are sensed even after the self-healing in the electronic device according to an embodiment of the present disclosure.

According to an embodiment of the present disclosure, a device lifespan may be increased by introducing the self-healing material.

In addition, according to an embodiment of the present disclosure, as the oxime-carbomate bond having the dynamic covalent bond activated at the specific temperature may be introduced, the polymer having the durable characteristic, and the selectively self-healing function may be synthesized, and the self-healing material may be introduced, thereby increasing the device lifespan.

In addition, according to the present disclosure, the self-healing characteristic of the material having the self-healing function is adjusted to appear at a specific temperature or more, thereby selectively controlling the self-healing characteristic.

Meanwhile, the effects produced by the present disclosure are not limited to the aforementioned effects, and any other effects not mentioned herein will be clearly understood from the following description by those skilled in the art to which the present disclosure pertains.

The above description has been made for the illustrative purpose. Furthermore, the above-mentioned contents describe the embodiment of the present disclosure, and the present disclosure may be used in various other combinations, changes, and environments. That is, the present disclosure may be modified and corrected without departing from the scope of the present disclosure that is disclosed in the specification, the equivalent scope to the written disclosures, and/or the technical or knowledge range of those skilled in the art. The written embodiment describes the best state for implementing the technical spirit of the present disclosure, and various changes required in the detailed application fields and purposes of the present disclosure can be made. The written embodiment describes the best state for implementing the technical spirit of the present disclosure, and various changes required in the detailed application fields and purposes of the present disclosure may be made. Furthermore, it should be construed that the attached claims include other embodiments.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method for producing a self-healing polymer, the method comprising:
A) allowing polytetramethylene glycol (PTMG) and diisocyanate to react with each other at a first temperature;
B) adding dimethylglyoxime (DMG) serving as a chain extender, which is melted in tetrahydrofuran (THF) serving as a solvent, to react with the reaction product in A) at a second temperature lower than the first temperature;
C) reducing a temperature of a reaction product in B) to a third temperature lower than the second temperature and adding polydimethylsiloxane (PDMS), which is melted in the THF, such that the PDMS melted in the THF is allowed to react with the reaction product in B);
D) adding a crosslinker, which is melted in the THF, to a reaction product in C) and stirring the crosslinker and the reaction product in C); and
E) obtaining a polymer cured as a solvent is removed from a reaction product in D).

2. The method of claim 1, wherein the PTMG constitutes a soft segment of the self-healing polymer, and
wherein the diisocyanate constitutes a hard segment of the self-healing polymer.

3. The method of claim 2, wherein the soft segment and the hard segment form a dynamic covalent bond.

4. The method of claim 3, wherein the soft segment and the hard segment form an oxime-carbamate bond having the dynamic covalent bond activated at a preset threshold temperature.

5. The method of claim 4, wherein the threshold temperature is higher than a glass transition temperature of the self-healing polymer produced.

6. The method of claim 1, wherein the diisocyanate includes:
at least one selected from the group consisting of isophorone diisocyanate, methylene diphenyl diisocyanate, and hexamethylene diisocyanate,

7. The method of claim 1, wherein the crosslinker includes:
at least one selected from the group consisting of diethylene triamine, meta-phenylene diamine, tetraethylene pentamine, diethanolamine, and triethanolamine.

8. The method of claim 1, wherein a molar proportion of the PDMS is 25% or less with respect to the PTMG.

9. The method of claim 7, wherein the crosslinker is added in a proportion ranging from 1% to 2% based on a volume ratio of the solvent.

10. A self-healing polymer produced through the method for producing the self-healing polymer according to claim 1.

11. The self-healing polymer of claim 10, wherein the self-healing polymer is split physically, and bonded physically, as self-healing is activated at at least a preset threshold.

12. An electronic device including the self-healing polymer according to claim 10.
